(19) United States
(12) Patent Application Publication
(10) Pub. No.: US 2007/0067381 A1
(43) Pub. Date: Mar. 22, 2007

(54) SYSTEMS AND METHODS FOR PROVIDING DISTRIBUTED APPLICATIONS AND SERVICES FOR INTELLIGENT MOBILE DEVICES

(75) Inventors: Bruce K. Grant JR., Pleasant Grove, UT (US); Scott A. Hawker, Springville, UT (US)

Correspondence Address: MADSON & AUSTIN;GATEWAY TOWER WEST, SUITE 900, 15 WEST SOUTH TEMPLE, SALT LAKE CITY, UT, 84101, US

(73) Assignee: The SCO Group, Inc., Lindon, UT (US)

(21) Appl. No.: 11/533,347

(22) Filed: Sep. 19, 2006

Related U.S. Application Data
(60) Provisional application No. 60/718,833, filed on Sep. 19, 2005.

(51) Int. Cl. G06F 15/16

(52) U.S. Cl. 709/200; 713/168

(57) ABSTRACT

In accordance with an embodiment, an edge processor may be configured to communicate with intelligent mobile devices via one or more mobile device networks. The edge processor may also be configured to access an entity's applications and data via a network of the entity. The edge processor may include one or more embedded applications. The edge processor may also include a command processor that is configured to route requests received from the intelligent mobile devices to the one or more embedded applications. The edge processor may also include at least one agent broker component that is configured to broker requests made from the one or more embedded applications to the entity's applications and data. At least one intelligent agent may facilitate communication between the one or more embedded applications and the entity's applications and data via the at least one agent broker component.

### RELATED APPLICATIONS

This application is related to and claims priority from U.S. patent application Ser. No. 60/718,833 filed Sep. 19, 2005, for “Distributed Applications And Services For Smart Handheld Devices,” with inventors Bruce K. Grant, Jr. and Scott A. Hawker, which is incorporated herein by reference.

### TECHNICAL FIELD

The present invention relates generally to computers and computer-related technology. More specifically, the present invention relates to systems and methods for providing distributed applications and services for intelligent mobile devices.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller, a one-board type of computer, such as a controller, a typical desktop computer, such as an IBM-PC compatible, etc.

The term “smart phone” (sometimes referred to as an “sphone”) may refer to any electronic handheld device that integrates the functionality of a mobile phone, personal digital assistant (PDA) or other information appliance. For example, telephone functions may be added to an existing PDA. Alternatively, “smart” capabilities (such as PDA functions) may be added to a mobile phone. Smart phones may also be referred to as intelligent mobile devices, or intelligent handheld devices. Some features of intelligent mobile devices may include Internet access, e-mail access, scheduling software, built-in camera software, contact management software, GPS navigation software and possibly the ability to read business documents in a variety of formats such as PDF and Microsoft Office. One feature of some smart phones is that additional native applications may be installed on the device. The applications can be developed by the manufacturer of the handheld device, by the operator, or by any other third-party software developer.

Intelligent mobile devices possess great potential for sophisticated applications that access real-time data over the Internet or a local network. Despite this, most organizations do not find relevant business solutions with the capabilities and features that utilize the full potential of the intelligent mobile device. Accordingly, benefits may be realized by systems and methods for providing distributed applications and services for intelligent mobile devices. Such systems and methods are disclosed herein.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 illustrates an exemplary system in which embodiments may be practiced, the system including an edge processor;

FIG. 2 illustrates some aspects of the operation of an authentication/authorization component and a command processor component within an edge processor in accordance with an embodiment;

FIG. 3 illustrates some aspects of the operation of an embedded application, an agent broker component, and an intelligent agent component in accordance with an embodiment;

FIG. 4 illustrates some aspects of the operation of a device formatter component and a messaging component in accordance with an embodiment;

FIG. 5 illustrates exemplary interfaces that may be implemented by an enterprise broker component in accordance with an embodiment;

FIG. 6 illustrates some aspects of the operation of a quality of service (QoS) component in accordance with an embodiment;

FIG. 7 illustrates information about a registered embedded application that may be maintained/accessed by an edge processor in accordance with an embodiment;

FIG. 8 illustrates information about a registered intelligent agent that may be maintained/accessed by an agent broker in accordance with an embodiment;

FIG. 9 illustrates an exemplary broker/agent interface that may be implemented in accordance with an embodiment;

FIG. 10 illustrates a mechanism for enhancing security for communications between an intelligent agent and an intelligent mobile device in accordance with an embodiment;

FIG. 11 illustrates a metric tracking framework in accordance with an embodiment;

FIG. 12 illustrates a method for processing incoming requests from intelligent mobile devices in accordance with an embodiment; and

FIG. 13 illustrates various hardware components that may be utilized within a computing device on which an edge processor may operate.

### DETAILED DESCRIPTION

A system for providing distributed applications and services for intelligent mobile devices is disclosed. The system may include an edge processor. The edge processor may be configured to communicate with intelligent mobile devices via one or more mobile device networks. The edge processor may be configured to access an entity's applications and data via a network of the entity.

The edge processor may include one or more embedded applications. The edge processor may include a command processor that is configured to route requests received from the intelligent mobile devices to the one or more embedded applications. The edge processor may include at least one agent broker component that is configured to broker requests made from the one or more embedded applications to the entity's applications and data.

The system may include at least one intelligent agent. The at least one intelligent agent may be configured to facilitate communication between the one or more embedded applications and the entity's applications and data via the at least one agent broker component.

In an embodiment, the edge processor may include an authentication/authorization component. The authentication/authorization component may be configured to examine credentials within requests that are received from the intelligent mobile devices to verify authorization to perform one or more specified operations.

In an embodiment, the edge processor may include an enterprise broker component that enables the edge processor to access entity-specific user and organizational information. The enterprise broker component may include an implementation of an organization interface that facilitates access to information about an organizational structure of the entity. The enterprise broker component may include an implementation of a security interface that facilitates verification of user-provided security credentials. The enterprise broker component may include an implementation of a communication interface that facilitates communication with the intelligent mobile devices.

In an embodiment, the edge processor may include a device formatter component. The device formatter component may be configured to convert data that is being sent to an intelligent mobile device into a format that is specific to the intelligent mobile device.

In an embodiment, the edge processor may include a quality of service component. The quality of service component may be configured to determine status information about other components of the edge processor.

In an embodiment, the edge processor may include a messaging component. The messaging component may be configured to send messages to the intelligent mobile devices.

In an embodiment, the edge processor may be configured to receive registration of the one or more embedded applications. In an embodiment, the at least one agent broker component may be configured to receive registration of the at least one intelligent agent.

In an embodiment, the at least one intelligent agent may implement a broker/agent interface. The broker/agent interface may facilitate communication between the at least one intelligent agent and the at least one agent broker.

In an embodiment, other components of the edge processor may be made available to the one or more embedded applications as web services. In an embodiment, the one or more embedded applications may be selected from the group consisting of self-contained applications, business integration applications, metric tracking applications, and mobile database applications.

A method for processing incoming requests from intelligent mobile devices is also disclosed. The method may be implemented by an edge processor. A request may be received from an intelligent mobile device to perform at least one operation. A user that originated the request may be identified. It may be verified that the user is authorized to perform the at least one operation. If the user is authorized to perform the at least one operation, an application that is embedded within the edge processor and that is configured to perform the at least one operation may be identified. A response may be received from the embedded application when the embedded application performs the at least one operation. The response may be translated into a format that corresponds to the intelligent mobile device that sent the request, thereby obtaining a translated response. The translated response may be sent to the intelligent mobile device.

In an embodiment, information about the request may be recorded in a log. In an embodiment, a transmission mechanism that is most likely to deliver the response to the user may be identified. The translated response may be sent via the transmission mechanism that is identified.

In an embodiment, the request may include an application code corresponding to the embedded application. In an embodiment, the request may include an operation code corresponding to the at least one operation.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

As used herein, the terms “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not necessarily all) embodiments of the disclosed invention(s),” unless expressly specified otherwise.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

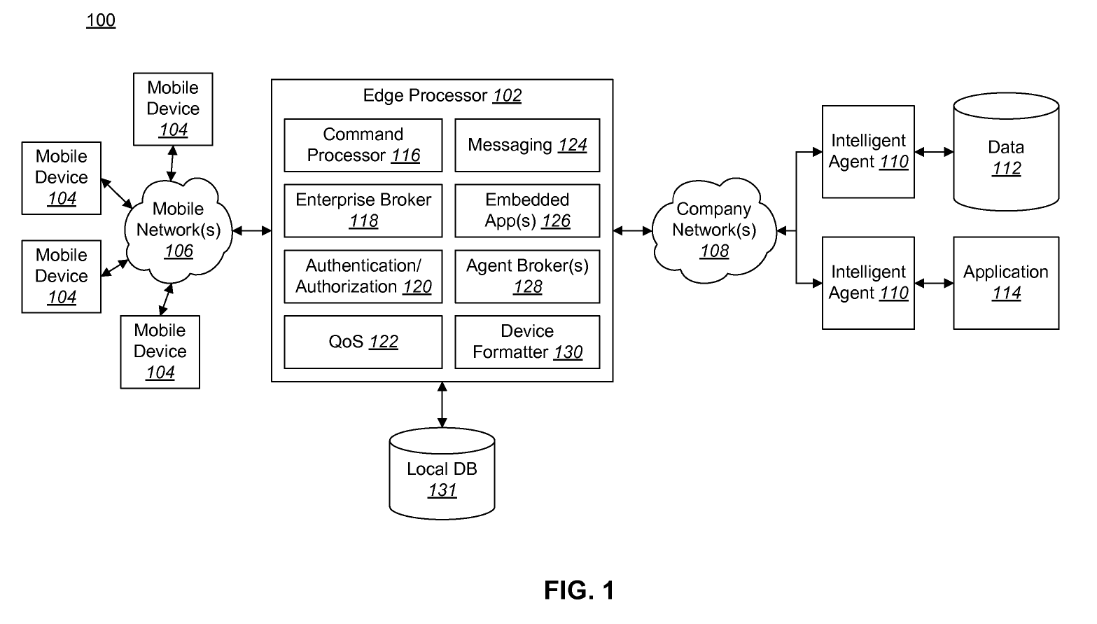

FIG. 1 illustrates an exemplary system 100 in which embodiments may be practiced. In accordance with an embodiment, an edge processor 102 may be provided. The edge processor 102 may enable a company (or other entity) to utilize intelligent mobile devices 104 as a solution for accessing and acting on data and events. As mentioned above, some examples of intelligent mobile devices may include smart phones, personal digital assistants (PDAs), pocket PCs, and the like.

The edge processor 102 may be installed within a company's network 108. The edge processor 102 may be configured to communicate with intelligent mobile devices 104 via one or more mobile device networks 106 (e.g., cellular networks). The edge processor 102 may provide a single connection path from intelligent mobile devices 104 to IP-based systems, off-load computing tasks and data storage from mobile end-user devices 104, and enable secure access and control for data that is provided to a mobile device 104.

One or more intelligent agents 110 may also be provided. The intelligent agent(s) 110 may connect a company's proprietary data 112 and/or applications 114 to intelligent mobile devices 104. The intelligent agent(s) 110 may leverage standards such as web services to broker communication between the edge processor 102 and the specific application 114 or database 112. The intelligent agent(s) 110 may use web services as a mechanism for communicating with intelligent mobile devices 104. The intelligent agent(s) 110 may secure and control access to data 112 and applications 114, and may provide data encryption using the Secure Socket Layer (SSL) protocol. Additionally, the intelligent agent(s) 110 may provide quality of service capabilities.

In general terms, the edge processor 102 may include a controller that routes incoming requests to an appropriate embedded application 126, which may respond to the request. More specifically, the edge processor 102 may field requests from an application running on an intelligent mobile device 104, find the right embedded application 126 to perform the requested operation(s), facilitate communication with a company's databases 112 or applications 114 if necessary, and convert the resulting data into a device-specific format. The edge processor 102 may include a number of components that implement this functionality.

For example, the edge processor 102 may include a command processor component 116. The command processor 116 may receive requests to do work or get data from a client on an intelligent mobile device 104. In response to receiving a request, the command processor 116 may route the request to the appropriate embedded application 126.

The edge processor 102 may also include an enterprise broker component 118. It may be desirable for the edge processor 102 to know who the users of the system 100 are in order to secure access to the system 100. Likewise, it may be desirable for the edge processor 102 to understand the organizational structure of a company in order to understand the relationships between users of the system 100. The enterprise broker component 118 may be thought of as a built-in integration agent that enables the edge processor 102 to access company-specific user and organizational information. The enterprise broker component 118 may also enable the edge processor 102 to integrate with a company's internal systems (if desired) including human resources data, company e-mail, directory, and so forth.

The edge processor 102 may also include an authentication/authorization component 120. The authentication/authorization component 120 may examine credentials included within requests from intelligent mobile devices 104. For each request that is received, the authentication/authorization component 120 may ensure that the requestor is a valid user of the system 100 and that the user is allowed to perform the requested operation(s) and/or access the requested data. In other words, the authentication/authorization component 120 may verify the identity and privileges of a user to perform a given request.

The edge processor 102 may also include a quality of service (QoS) component 122. The QoS component 122 may monitor other components of the edge processor 102 and/or the system 100. When problems related to accessing required resources are detected, the QoS component 122 may take specified action(s) to ensure the appropriate parties are notified and the system 100 remains accessible.

The edge processor 102 may also include a messaging component 124. The messaging component 124 may be configured to send messages (e.g., text messages, multi-media messages, etc.) to different users of the system 100, utilizing the messaging technology that is appropriate for each user.

The edge processor 102 may also include one or more embedded applications 126. The applications 126 may be treated as plug-ins that extend the capabilities of the overall platform. The other components of the edge processor 102 may be made available as services to each embedded application 126 to enable the application 126 to integrate with the edge processor 102 as a whole in responding to requests made to the application 126 to do work and get data. In an embodiment, each application 126 that embeds within the edge processor 102 may be implemented as a web service that includes a few specific operations, enabling this component to broker communication between the edge processor 102 and the embedded application 126. Secure Sockets Layer (SSL) communication may be utilized from/to every component of the system 100, which may include web services invocations from the edge processor 102 to an embedded application 126.

The edge processor 102 may also include one or more agent broker components 128. The edge processor 102 may use the agent broker(s) 128 to protect the security and integrity of a company's data 112 and/or applications 114 by preventing embedded applications 126 from directly interacting with any company data 112 and/or applications 114. The agent broker(s) 128 may be used to broker requests made from a specific embedded application 126 to a company's proprietary applications 114 and data 112 on behalf of an embedded application 126. This has the effect of enforcing encryption and security methodologies as well as managing access controls to the company applications 114 and data 112. In an embodiment, the agent broker(s) 128 may communicate directly with intelligent agents 110 deployed within the company's network 108 that abstract a proprietary application 114 or data source 112 into a generic web service interface.

The edge processor 102 may also include a device formatter component 130. The device formatter 130 may convert data that is being sent to an intelligent mobile device 104 into a device-specific (and possibly native) format. The device formatter component 130 may be included within the edge processor 102 in order to ensure optimal performance of applications on intelligent mobile devices 104 as they request data over mobile device networks 106.

As briefly discussed above, it may be desirable for the edge processor 102 to request data from company-specific applications 114 and data repositories 112 in a secure manner while providing security, access control and quality of service. It may also be desirable for the edge processor 102 to provide this integration capability without adding a great deal of complexity and yet be flexible enough to facilitate the integration of any number of disparate applications 114 and databases 112. To facilitate this, one or more intelligent agents 110 may be provided, as mentioned above. An intelligent agent 110 may be implemented as a web service that is accessible to the edge processor 102 inside a network 108. The intelligent agent 110 web service may implement a specific, defined interface to ensure interoperability with the overall platform, and may include additional services that are specific to the application 114 or data 112 accessed by the web service.

In an embodiment, the edge processor 102 may execute within a Java application server as a Java 2 Platform, Enterprise Edition (J2EE) web application. The edge processor 102 may be configured to communicate with clients over the standard HTTP protocol, whether the clients are mobile devices 104 or web sites. The edge processor 102 may communicate with clients using Secure Sockets Layer (SSL) encryption.

Different types of embedded applications 126 may be provided. In an embodiment, (at least) four different types of embedded applications 126 may be provided: self-contained applications, business integration applications, metric tracking applications (which may be referred to as heartbeat applications), and mobile database applications.

With self-contained applications, the focus may be centered around subscriber data (groups, contacts, etc.). The edge processor 102 may perform most or all data processing. The edge processor 102 may store application data in local databases 131. It may not be necessary to connect to existing applications 114, so there may not be a need for any agents 110. Self-contained applications may not require web administrator pages. Self-contained applications may be tied to “landing pages,” application web pages, etc.

Business integration applications may connect to an existing application 114. Accordingly, one or more intelligent agents 110 may be provided. The purpose of business integration applications may include data collection, data processing, transaction processing, and so forth. With business integration applications, the edge processor 102 primarily acts like a switch. One or more databases 131 local to the edge processor 102 may be used to route a request to the proper agent 110. Much of the processing may be done by intelligent agents 110 and clients. Web administrator pages may be used to manage the intelligent agents 110.

Metric tracking applications (also known as heartbeat applications) may be thought of as a variant of business integration applications. A metric tracking application may be configured to track business and system metrics. For example, a metric tracking application may allow a user to view help indicators (business statistics, system performance monitors, etc.), receive alerts based on user-defined indicators, and/or take actions to correct problems. Metric tracking applications may be thought of as combining a service-oriented architecture with an event-driven architecture.

Mobile database applications may include a full application database. Processing may be located on a mobile client. Data may be periodically synchronized with a server. Mobile database applications may be thought of as being “client-centric.”

As a specific example of an embedded application 126 that may be used, a poll-taking application may allow a service subscriber to send an email question out for a vote. The client interface on the intelligent mobile device 104 may include forms that allow the subscriber to compose, address, and send the vote out to a contact list. Recipients of the vote may interact with the edge processor 102 through HTTPS messages delivered from a variety of intelligent mobile devices 104. The components within the edge processor 102 may handle the work of managing the contact, recipient, and subscriber lists; sending and receiving the votes; tabulating the results; providing a landing page where the results can be viewed, etc. The only data from outside the edge processor 102 may be the corporate data (names, emails, etc.) that may be required to send the poll. In an implementation, this may be done without agents 110, but rather a simple broker 128 that keeps the subscriber database local to and used by the edge processor and in sync with the corporate database 112. Accordingly, all the processing may take place on the edge processor 102. The poll-taking application described in this example may be thought of as a self-contained application.

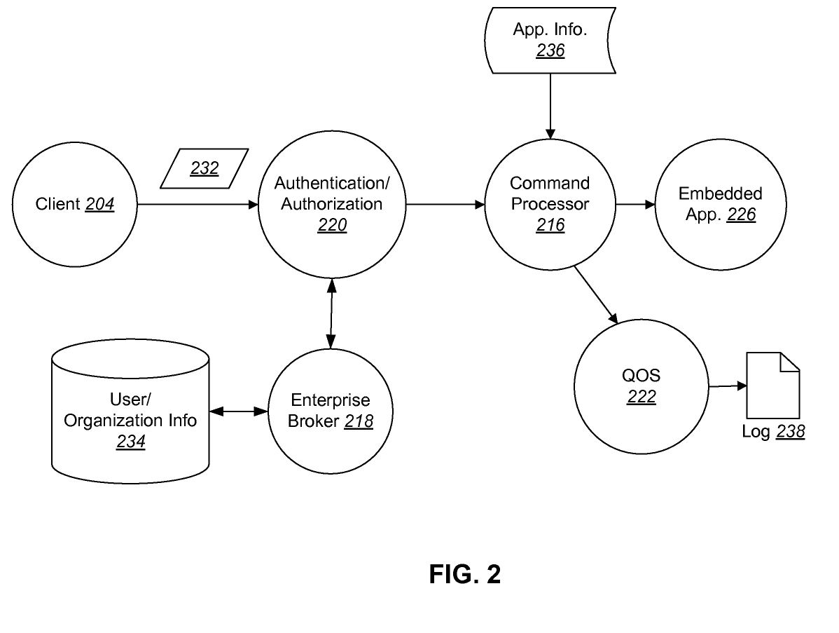

Referring now to FIG. 2, in accordance with an embodiment a client 204 running on an intelligent mobile device 104 may send a request 232 to the edge processor 102. Credentials may be included with the request 232 to indicate which user is making the request 232. The request 232 may initially be handled by an authentication/authorization component 220. The authentication/authorization component 220 may use an enterprise broker 218 to determine and validate the identity of the originator of the request 232, and to verify that the user is authorized to make the request 232. This may involve accessing user and/or organization information 234.

The request 232 may then be passed to a command processor 216. The command processor 216 may identify an embedded application 226 that corresponds to the request 232 (e.g., that is configured to respond to the request 232) and may send the request 232 to the identified embedded application 226. A QoS component 222 may record information about the processing of the request 232 in a log 238.

In an embodiment, the request 232 may include (at least) two pieces of information that facilitate processing of the request 232. In particular, the request 232 may include an application code. The application code may specify a particular embedded application 226 to receive the request 232. The application code may be used by the command processor 216, along with application information 236, to determine which embedded application 226 the request is routed to. The request 232 may also include an operation code. The operation code may specify one or more operations to be executed by the embedded application 226 in response to receiving the request 232.

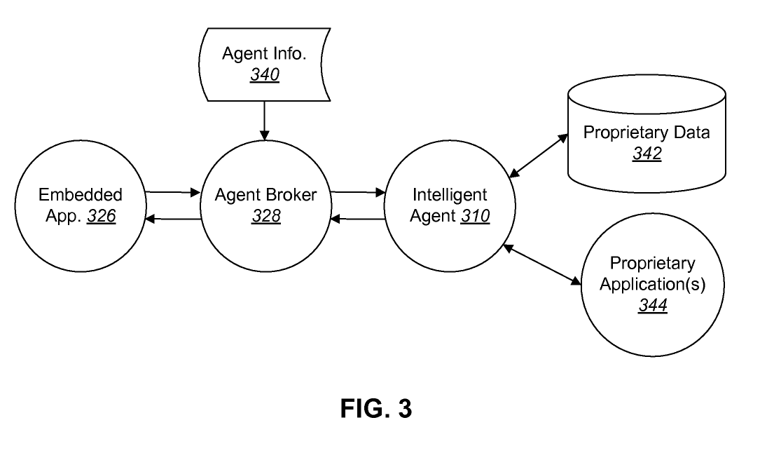

Referring now to FIG. 3, in accordance with an embodiment an agent broker 328 may act as an intermediary between an embedded application 326 and a deployed intelligent agent 310. (As mentioned, an intelligent agent 310 may connect a company's proprietary data 342 and/or applications 344 to intelligent mobile devices 104.) Such a configuration may allow the agent broker 328 to enforce security and quality of service. In an embodiment, the agent broker 328 may not permit access to any web service unless it uses the Secure Sockets Layer (SSL) to access the service.

An intelligent agent 320 may register with an agent broker 328. A variety of information 340 about each registered intelligent agent 310 may be maintained by and/or accessible to the agent broker 328. This will be described in greater detail below.

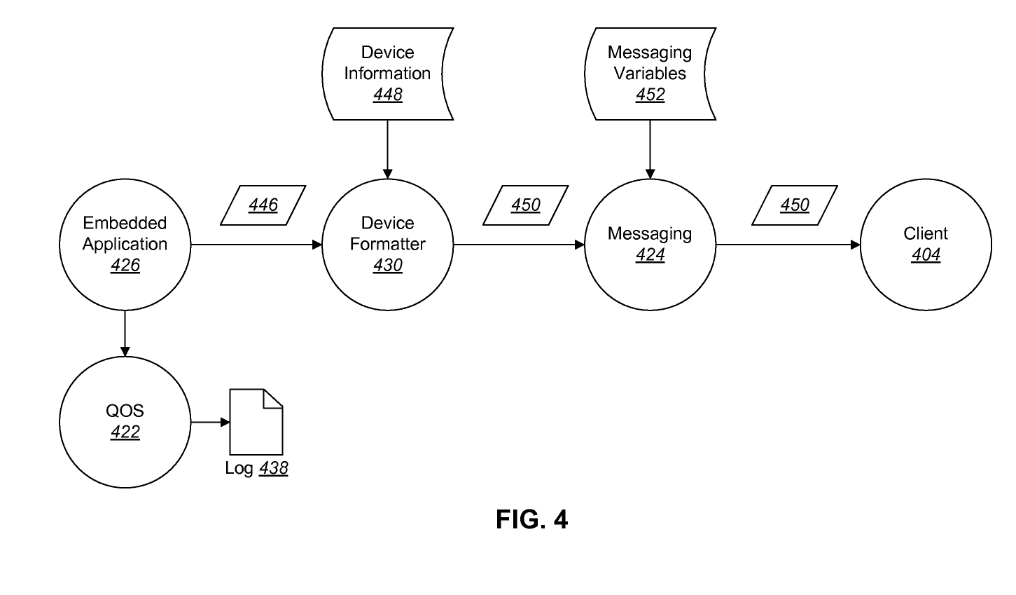

Referring now to FIG. 4, in accordance with an embodiment an embedded application 426 may execute logic to fulfill a request 232 from an intelligent mobile device 104 and return a response 446 as appropriate. A QoS component 422 may record information about the response 446 payload in a log 438.

A device formatter 430 may translate the response 446 into a format that is appropriate for the mobile device 104 that made the corresponding request 232. This may involve accessing device information 448, which may contain information about the format(s) in which a particular device 104 expects to receive data. For example, if the device 104 that made the request 232 is a Treo 650, the device formatter 430 may take the response XML and convert it into a Palm OS-specific database (PDB) that includes that data as well as XML markup governing how the data should be presented, stored and cached on the Treo 650 device. In an embodiment, the QoS component 422 may record information about the response 446 payload before the device formatter 430 translates the response 446.

A messaging component 424 may be used to send the translated response 450 to the client 404 that sent the corresponding request 232. In an embodiment, the messaging component 424 may be configured to determine the transmission mechanism (e.g., text message, email, etc.) that is most likely to deliver a message that a user can receive right now (e.g., at the time that the message is being sent). It is possible that not every system user will have a smart phone device that is capable of receiving more advanced messages in real-time. It is also possible that not every system user will have a cell phone. Moreover, it may be that not every message that is sent is destined for an actual system user; some messages may be destined for someone outside the system. The messaging component 424 may be configured to take all such variables 452 into account in determining how to send a message. In an embodiment, the messaging component 424 may be configured so that as a last resort the messaging component 424 translates messages into a form that can be sent to a user's traditional email account.

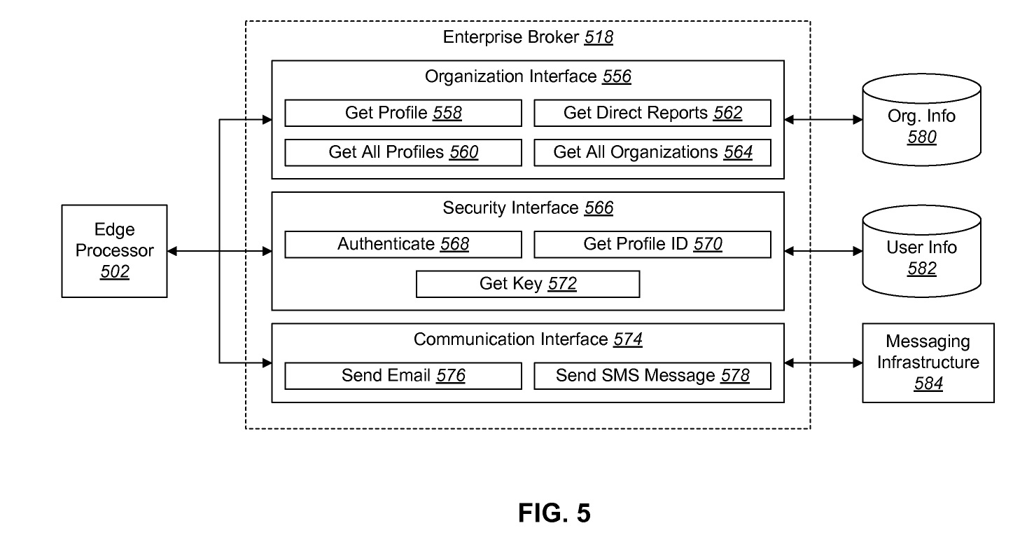

Referring now to FIG. 5, in accordance with an embodiment an enterprise broker 518 may define a set of interfaces in order to integrate a company's (or other type of organization's) core data with an edge processor 502. For example, the enterprise broker 518 may implement an organization interface 556. The components within an edge processor 502 may be able to access information 580 about the organizational structure of a company or other entity using implementations of the organization interface 556.

The organization interface 556 may support a get profile method 558. When called, the get profile method 558 may return a user of the system. In an embodiment, the get profile method 558 may be defined as follows:

// Returns a user of the system
Profile getProfile(String requestorId, String profileId);

The organization interface 556 may also support a get all profiles method 560. When called, the get all profiles method 560 may return all users of the system. In an embodiment, the get all profiles method 560 may be defined as follows:

// Returns all users of the system
List<Profile> getAllProfiles(String requestorId);

The organization interface 556 may also support a get direct reports method 562. When called, the get direct reports method 562 may return all users that report to a specified user. In an embodiment, the get direct reports method 562 may be defined as follows:

//Returns all users that report to the given user
List<Profile> getDirectReports(String requestorId, String profileId);

The organization interface 556 may also support a get all organizations method 564. The get all organizations method 564 may return all organizations within a company. In an embodiment, the get all organizations method 564 may be defined as follows:

// Returns all organizations within the company:
// for example, Human Resources, Manufacturing, IS, etc.
List<Organization> getAllOrganizations(String requestorId);

The enterprise broker 518 may also implement a security interface 566. The components within an edge processor 502 may verify user-provided credentials (e.g., by accessing user information 582) using implementations of the security interface 566.

The security interface 566 may support an authenticate method 568. When called, the authenticate method may determine whether user-provided credentials (which, as discussed above, may be included within a request 232 from an intelligent mobile device 104) represent a valid user of the system. In an embodiment, the authenticate method 568 may be defined as follows:

// Authenticates the given credentials represent a
// valid user of the system

String authenticate(String username, String password);

The security interface 566 may also support a get profile identifier method 570. When called, the get profile identifier method 570 may convert user-provided credentials into a unique, meaningless identifier. In an embodiment, the get profile identifier method 570 may be defined as follows:

// Convert user credentials into unique, meaningless ID
String getProfileId(String username, String key);

The security interface 566 may also support a get key method 572. When called, the get key method 572 may return a security key which verifies a system command's authenticity. In an embodiment, the get key method 572 may be defined as follows:

// A security key which verifies a system command's
// authenticity
String getKey( );

The enterprise broker 518 may also implement a communication interface 574. The edge processor 502 may send messages (e.g., by utilizing a company's messaging infrastructure 584) using implementations of the communication interface 574.

The communication interface 574 may support a send email method 576. The send email method 576 may be called by components of the edge processor 502 in order to send an email to a specified user. In an embodiment, the send email method 576 may be defined as follows:

```
// Sends an email message
void sendEmail(List<String> toEmailAddrs, String
  fromEmailAddr, String fromDisplayName,
  String subject, String message);
```

The communication interface 574 may also support a send SMS message method 578. The send SMS message method 578 may be called by components of the edge processor 502 in order to send a Short Message Service (SMS) message to a specified user. In an embodiment, the send SMS message method 578 may be defined as follows:

// Send an SMS message
sendSMS(List<String> toSMSNumbers, String fromEmail,
String fromDisplayName, String message);

In an embodiment, the edge processor 502 may include a default implementation of the communication interface 574. The default implementation may be used to more quickly achieve integration with a company's messaging infrastructure 584. The default implementation may use simple username/password credentials stored in a relational database with the password encrypted.

The edge processor 502 may also include a default implementation of the organization interface 556 and the security interface 566. Installation of the default implementations may be accomplished with manual entry of user information or conformance to a few document types to achieve automated integration.

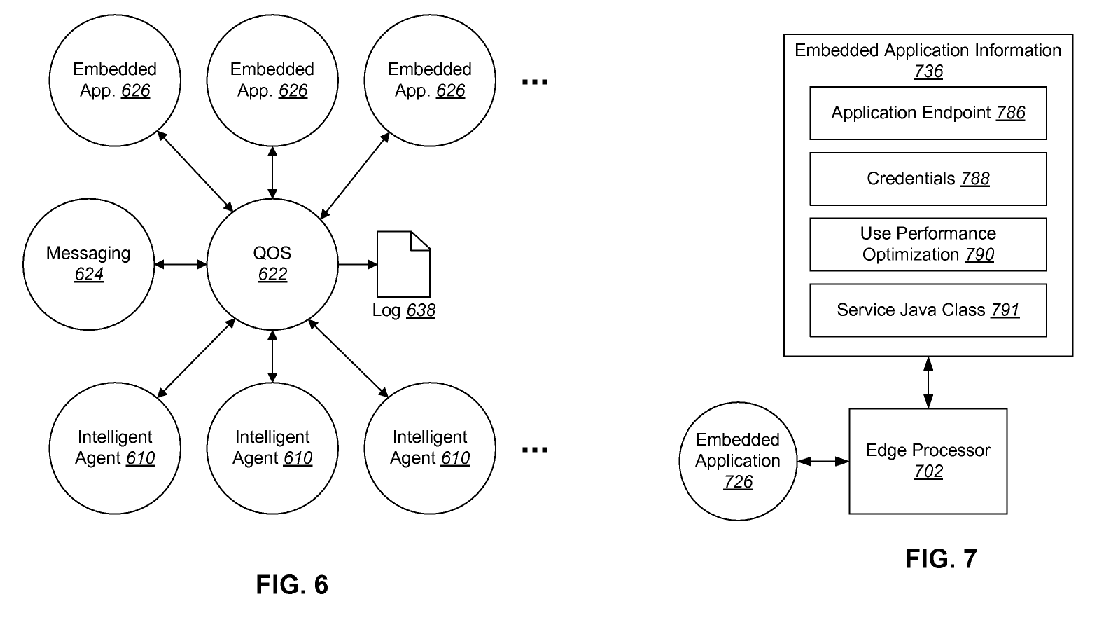

Referring now to FIG. 6, in accordance with an embodiment a QoS component 622 may be configured to record information about activity within the system (e.g., requests, responses, etc.). This information may be recorded in a log 638.

In addition, the QoS component 622 may be configured to monitor the status of some or all of the components of the system. For example, the QoS component 622 may monitor one or more embedded applications 626. Each embedded application 626 within the system may include a service method indicating the current status of that application 626. The QoS component 622 may constantly (e.g., periodically) invoke that service method to ensure the status of the embedded application 626 is normal. Should the embedded application 626 ever indicate a status other than normal, the QoS component 622 may take action appropriate for the status indicated (e.g., making a call to a messaging component 624 to send a notification message to a system administrator, etc.).

The QoS component 622 may also monitor the status of one or more intelligent agents 610 within the system. Each intelligent agent 610 within the system may include a service method indicating the current status of that agent 610. The QoS component 622 may constantly (e.g., periodically) invoke that service method to ensure the status of the intelligent agent 610 is normal. Should the intelligent agent 610 ever indicate a status other than normal, the QoS component 622 may take action appropriate for the status indicated (e.g., making a call to the messaging component 624 to send a notification message to a system administrator, etc.).

Referring now to FIG. 7, in accordance with an embodiment an embedded application 726 may register with an edge processor 702. This may be done in a variety of ways, such as by using an administrative console. A variety of information 736 about each registered embedded application 726 may be maintained by and/or accessible to the edge processor 702.

For example, the information 736 that may be maintained/accessed about a specific embedded application 726 may include an application endpoint 786. The application endpoint 786 may be a URL of a Web Services Description Language (WSDL) file that completely describes the operations included within the embedded application 726 web service as well as a URL by which the service itself may be accessed.

The information 736 about a particular embedded application 726 may also include credentials 788 for that application 726. It may be desirable for each embedded application 726 to communicate with the edge processor 702 and its various other components with complete confidence that the edge processor 702 has maintained the security and integrity of the system and its constituent modules. Accordingly, each embedded application 726 may register credentials 788 (e.g., username and password) with the edge processor 702. The edge processor 702 may send these credentials with every request to communicate with the embedded application 726 and in return the embedded application 726 may be required to send these credentials with each transaction it establishes with the edge processor 702.

The information 736 about a particular embedded application 726 may also include use performance optimization information 790. As mentioned above, the edge processor 702 may execute within a Java application server as a J2EE web application. If an embedded application 726 executes within the same Java Virtual Machine as the edge processor 702, direct method invocations may be used instead of more expensive web service invocations. If this is the case, the Java class that backs the web service may be provided as a performance optimization 790. In addition, the service Java class 791 may be provided. The service Java class 791 may be the fully qualified Java class whose methods may be invoked instead of calling the web service if the performance optimization 790 is being used, as specified above.

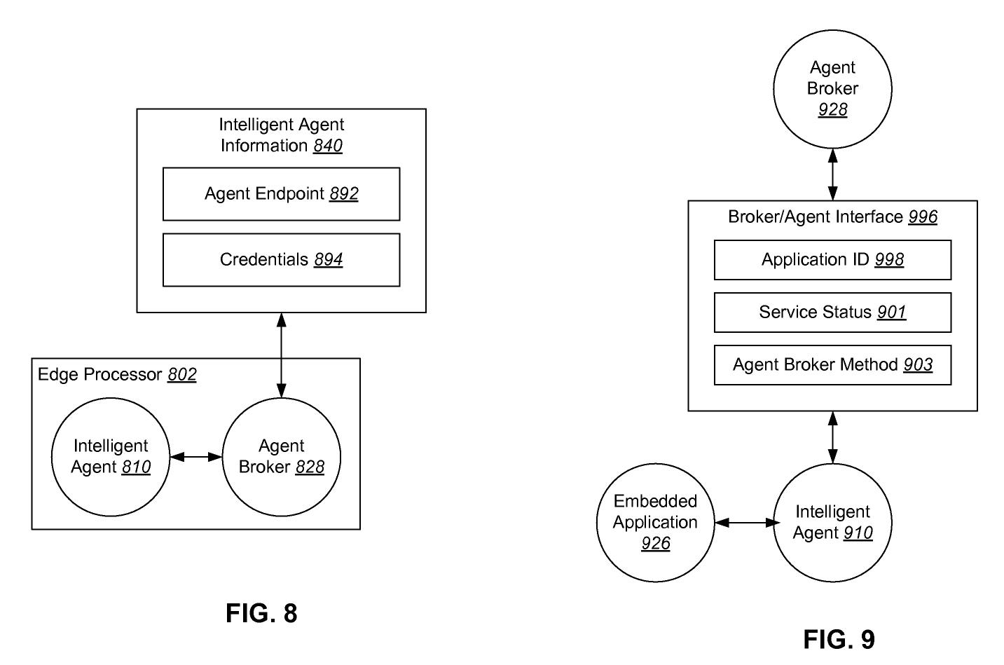

Referring now to FIG. 8, in accordance with an embodiment an intelligent agent 810 may register with an agent broker 828. This may be done in a variety of ways, such as by using an administrative console. A variety of information 840 about each registered intelligent agent 810 may be maintained by and/or accessible to the agent broker 828.

For example, the information 840 that may be maintained/accessed about a specific intelligent agent 810 may include an agent endpoint 892. The agent endpoint 892 may be a URL of an WSDL file that completely describes the operations included within the agent 810 web service as well as a URL by which the service itself may be accessed.

The information 840 that may be maintained/accessed about a specific intelligent agent 810 may also include credentials 894. It may be desirable for each intelligent agent 810 to communicate with a corresponding agent broker 828 with complete confidence that the edge processor 802 has maintained the security and integrity of the system and its constituent modules. Accordingly, each intelligent agent 810 may register credentials 894 (e.g., username and password) with the corresponding agent broker 828. The agent broker 828 may send these credentials with every request to communicate with the intelligent agent 810 and in return the intelligent agent 810 may be required to send these credentials with each transaction it establishes with the agent broker 828.

Referring now to FIG. 9, a broker/agent interface 996 may be implemented by an intelligent agent 910 in order to facilitate communication between the intelligent agent 910 and an agent broker 928. The broker/agent interface 996 may be a web service interface.

The broker/agent interface 996 may include an application identifier method 998. When called, the application identifier method 998 may return identifying information about the embedded application 926 that interacts with a specified agent 910. In an embodiment, the application identifier method 998 may be defined as:

public String getApplicationId( );

The broker/agent interface 996 may also include a service status method 901. When called, the service status method 901 may return information indicating whether or not a specified service is currently functioning correctly. In an embodiment, the service status method 901 may be defined as:

public Status Value getServiceStatus( );

Status Value={OPERATIONAL, NOT_OPERATIONAL};

The broker/agent interface 996 may also include an agent broker method 903. The agent broker method 903 may be invoked by the agent broker 928. The agent broker 928 may pass an object that allows the service to initiate communication with an edge processor 102.

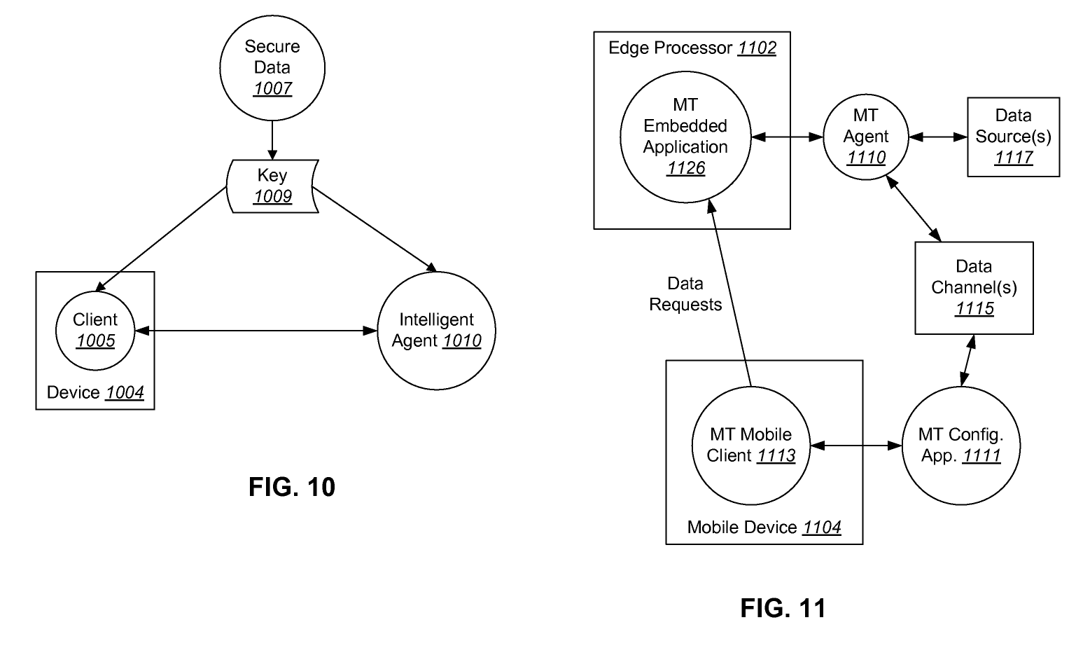

Referring now to FIG. 10, if it is desirable for data communication between an intelligent agent 1010 and a client 1005 running on an intelligent mobile device 1004 to be encrypted and secured as the data moves from the intelligent agent 1010 to the intelligent mobile device 1004 (or vice versa), an additional layer of security may be used. In particular, a secure data application 1007 may be used to generate a key 1009, which may be based on a password. The key 1009 provided by the secure data application 1007 may be installed with the client 1005 on the intelligent mobile device 1004 and also with the intelligent agent 1010. That key 1009 may then be used to encrypt data communications between the intelligent agent 1010 and the client 1005.

As discussed above, in accordance with an embodiment different types of embedded applications 126 may be provided, including self-contained applications, business integration applications, metric tracking applications (which may be referred to as heartbeat applications), and mobile database applications. In accordance with an embodiment, a framework may be provided that enables metric tracking applications to be created without requiring a developer to code the new applications. The framework may allow a business user to specify the data or applications within his/her network he wishes to gain access to from a mobile client. The framework may do the work of getting the data, and the mobile client may re-assemble itself based on the data it receives, dynamically reforming to present the new data it has just received.

Referring now to FIG. 11, a metric tracking (MT) application framework may include an MT embedded application 1126, an MT configuration application 1111, and an MT mobile client 1113 running on a mobile device 1104. The MT embedded application 1126 may be embedded within an edge processor 1102, and may field requests for data from MT mobile clients 1113. The MT configuration application 1111 may allow a user (e.g., a business professional) within a network (e.g., a corporate network) to specify data and/or applications to be accessed from the MT mobile client 1113. The MT mobile client 1113 may allow a user to define a data channel 1115 to access via the server-hosted MT embedded application 1126. A data channel 1115 may represent a user-created set of aggregated data from one or more data sources 1117. A data channel 1115 may have a name and other rules associated with it governing its security, lifespan, etc. The MT mobile client 1113 may possess enough intelligence to determine how to re-assemble itself to present data to the user.

In accordance with an embodiment, the MT configuration application 1111 may be embodied as a website (e.g., a company's internal website). A user (e.g., a business professional within a company) may access the MT configuration application 1111 to decide what company data to receive on his/her mobile device 1104. In other words, the MT configuration application 1111 may be thought of as allowing a user to create a new mobile application. The user may define a data channel 1115 from a data source 1117 and may retrieve the data channel 1115 from the MT mobile client 1113 on his/her mobile device 1104. The business professional may be able to choose from each database 112, application 114, or combination of databases 112 and applications 114 that have been made available. The MT configuration application 1111 may display this list from the MT intelligent agent(s) 1110 that is/are registered with the MT embedded application 1126. An MT intelligent agent 1110 may be deployed for each database 112 and/or application 114 that the company wishes to make available to users of the MT application framework.

The MT embedded application 1126 may present a list of data sources 1117 that a user may choose from to create a new mobile application. The application 1126 may show one data source 1117 for each MT data source agent 1110 docked with the edge processor 1102. An MT agent/data source interface (explained in greater detail below) may be defined to provide sufficient meta-data that the MT configuration application 1111 may display the data source 1117 in a human-readable format to the end user. Each MT agent 1110 within the system may implement the MT agent/data source interface, thereby enabling it to provide data to a mobile device 1104 with an MT mobile client 1113.

A user may create data channels 1115 using the MT configuration application 1111. A data channel 1115 may encapsulate the data from one or more data sources 1117. Once defined, a user may access a data channel 1115 from a mobile device 1104 using credentials and the name of the data channel 1115.

In accordance with an embodiment, an MT embedded application 1126 may communicate with a data source 1117 as users make requests for data via the MT application framework. The MT embedded application 1126 may store user-created, named data channels 1115 to one or more MT intelligent agents 1110. The MT embedded application 1126 may also ensure that only authorized users are able to access MT intelligent agents 1110 through a data channel 1115 and that they have been granted permission to do so.

In accordance with an embodiment, an MT mobile client 1113 may be configured to access any data source 1117 within an organization (e.g., a company), whether the data source 1117 is a database or an application, as long as an agent 1110 exists to integrate the data from that company data source 1117. The agent 1110 may be implemented as a web service.

The MT mobile client 1113 may communicate with the edge processor 1102 running the MT embedded application 1126 within it. A user may enter the name of one or more data channels 1115 which may be defined via the MT configuration application 1111, thereby gaining access to the data flowing through that data channel 1115.

The MT mobile client 1113 may receive from the edge processor 1102 server both data and information about the structure of the data it is receiving. The client 1113 may contain sufficient intelligence to analyze the structure of the data and re-organize itself to present the data received using the most appropriate user interface metaphors (e.g., buttons, check boxes, lists, grids, etc.).

As mentioned, an MT agent/data source interface may be defined. The agent/data source interface may include a data source name method. When called, the data source name method may return the name that the MT configuration application 1111 may show to the user. In an embodiment, the data source name method may be defined as:

public String getDataSourceName( );

The agent/data source interface may also include a service descriptor method. When called, the service descriptor method may return a ServiceDescriptor object that may describe, in a human-readable format, the data and/or operations the agent 1110 publishes. The MT configuration application 1111 may use this ServiceDescriptor object to know what information to present to a user. In an embodiment, the service descriptor method may be defined as:

public ServiceDescriptor getServiceDescriptor( );

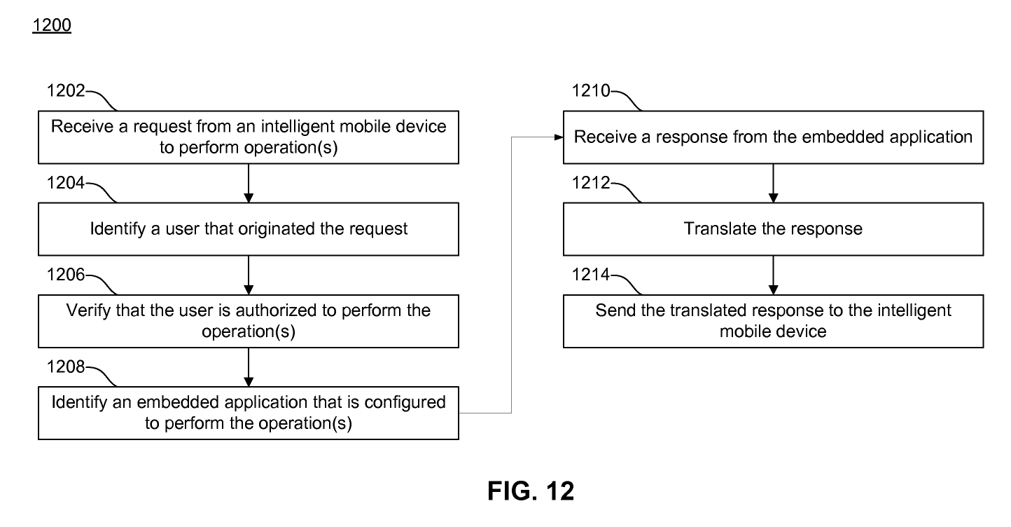

FIG. 12 illustrates a method 1200 for processing incoming requests from intelligent mobile devices 104 in accordance with an embodiment. A request 232 may be received 1202 from an intelligent mobile device 1202 to perform one or more operations. In response to receiving 1202 the request 232, the user that originated the request 232 may be identified 1204. The method 1200 may involve verifying 1206 that the user is authorized to perform the requested operation(s).

If the user is authorized to perform the requested operation(s), an embedded application 126 that is configured to perform the requested operation(s) may be identified 1208. The request 232 may be passed to the embedded application 126, and the embedded application 126 may perform the requested operation(s). When the requested operation(s) have been performed, the embedded application 126 may return a response 446, which may be received 1210. The response 446 may be translated 1212 into a format that is appropriate for the intelligent mobile device 104 that sent the request 232, and the translated response 450 may be sent 1214 to the intelligent mobile device 104.

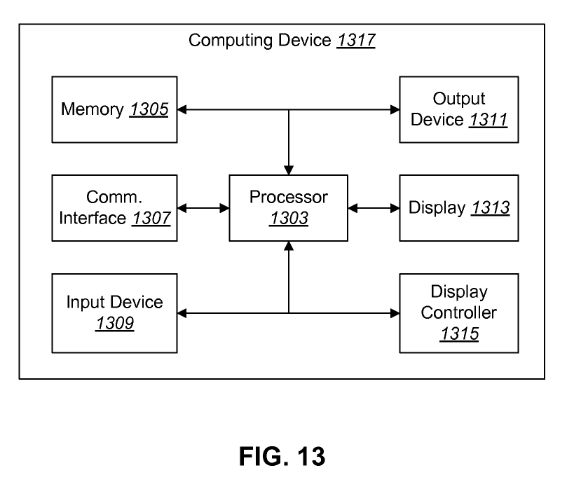

FIG. 13 illustrates various components that may be utilized in a computing device 1317, on which the various components of an edge processor 102 may operate. The illustrated components may be located within the same physical structure or in separate housings or structures.

The computing device 1317 may include a processor 1303 and memory 1305. The processor 1303 may control the operation of the computing device 1317 and may be embodied as a microprocessor, a microcontroller, a digital signal processor (DSP) or other device known in the art. The processor 1303 may perform logical and arithmetic operations based on program instructions stored within the memory 1305.

The computing device 1317 may include one or more communication interfaces 1307 for communicating with other electronic devices. The communication interfaces 1307 may be based on wired communication technology, wireless communication technology, or both. Examples of different types of communication interfaces 1307 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computing device 1317 may include one or more input devices 1309 and one or more output devices 1311. Examples of different kinds of input devices 1309 include a keyboard, mouse, microphone, remote control device, button, joystick, trackball, touchpad, lightpen, etc. Examples of different kinds of output devices 1311 include a speaker, printer, etc. One specific type of output device which is typically included in a computer system is a display device 1313. Display devices 1313 used with embodiments disclosed herein may utilize any suitable image projection technology, such as a cathode ray tube (CRT), liquid crystal display (LCD), light-emitting diode (LED), gas plasma, electroluminescence, or the like. A display controller 1315 may also be provided, for converting data stored in the memory 1305 into text, graphics, and/or moving images (as appropriate) shown on the display device 1313.

Of course, FIG. 13 illustrates only one possible configuration of a computing device 1317. Various other architectures and components may be utilized.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A system for providing distributed applications and services for intelligent mobile devices, comprising:
an edge processor that is configured to communicate with intelligent mobile devices via one or more mobile device networks and that is also configured to access an entity's applications and data via a network of the entity, the edge processor comprising:
one or more embedded applications;
a command processor that is configured to route requests received from the intelligent mobile devices to the one or more embedded applications; and
at least one agent broker component that is configured to broker requests made from the one or more embedded applications to the entity's applications and data; and
at least one intelligent agent that facilitates communication between the one or more embedded applications and the entity's applications and data via the at least one agent broker component.

2. The system of claim 1, wherein the edge processor further comprises an authentication/authorization component that is configured to examine credentials within requests that are received from the intelligent mobile devices to verify authorization to perform one or more specified operations.

3. The system of claim 1, wherein the edge processor further comprises an enterprise broker component that enables the edge processor to access entity-specific user and organizational information.

4. The system of claim 3, wherein the enterprise broker component comprises an implementation of an organization interface that facilitates access to information about an organizational structure of the entity.

5. The system of claim 3, wherein the enterprise broker component comprises an implementation of a security interface that facilitates verification of user-provided security credentials.

6. The system of claim 3, wherein the enterprise broker component comprises an implementation of a communication interface that facilitates communication with the intelligent mobile devices.

7. The system of claim 1, wherein the edge processor further comprises a device formatter component that is configured to convert data that is being sent to an intelligent mobile device into a format that is specific to the intelligent mobile device.

8. The system of claim 1, wherein the edge processor further comprises a quality of service component that is configured to determine status information about other components of the edge processor.

9. The system of claim 1, wherein the edge processor further comprises a messaging component that is configured to send messages to the intelligent mobile devices.

10. The system of claim 1, wherein the edge processor is configured to receive registration of the one or more embedded applications.

11. The system of claim 1, wherein the at least one agent broker component is configured to receive registration of the at least one intelligent agent.

12. The system of claim 1, wherein the at least one intelligent agent implements a broker/agent interface to facilitate communication between the at least one intelligent agent and the at least one agent broker.

13. The system of claim 1, wherein other components of the edge processor are made available as web services to the one or more embedded applications.

14. The system of claim 1, wherein the one or more embedded applications are selected from the group consisting of self-contained applications, business integration applications, metric tracking applications, and mobile database applications.

15. In an edge processor, a method for processing incoming requests from intelligent mobile devices, comprising:
receiving a request from an intelligent mobile device to perform at least one operation;
identifying a user that originated the request;
verifying that the user is authorized to perform the at least one operation;
if the user is authorized to perform the at least one operation, identifying an application that is embedded within the edge processor and that is configured to perform the at least one operation;
receiving a response from the embedded application when the embedded application performs the at least one operation;
translating the response into a format that corresponds to the intelligent mobile device that sent the request, thereby obtaining a translated response; and
sending the translated response to the intelligent mobile device.

16. The method of claim 15, further comprising recording information about the request in a log.

17. The method of claim 15, further comprising:
identifying a transmission mechanism that is most likely to deliver the response to the user; and
sending the translated response via the transmission mechanism that is identified.

18. The method of claim 15, wherein the request comprises an application code corresponding to the embedded application.

19. The method of claim 15, wherein the request comprises an operation code corresponding to the at least one operation.

20. A computer-readable medium comprising executable instructions for implementing a method for processing incoming requests from intelligent mobile devices, the method comprising:
receiving a request from an intelligent mobile device to perform at least one operation;
identifying a user that originated the request;
verifying that the user is authorized to perform the at least one operation;
if the user is authorized to perform the at least one operation, identifying an application that is embedded within the edge processor and that is configured to perform the at least one operation;
receiving a response from the embedded application when the embedded application performs the at least one operation;
translating the response into a format that corresponds to the intelligent mobile device that sent the request, thereby obtaining a translated response; and
sending the translated response to the intelligent mobile device.
